(19) United States
(12) Patent Application Publication
(10) Pub. No.: US 2010/0279197 A1
(43) Pub. Date: Nov. 4, 2010

(54) Membrane-electrode binder having dual electrode, method of manufacturing the binder, and fuel cell comprising the same

(75) Inventors: Hyoung-Juhn Kim, Suwon-si (KR); Jeung-woo Lee, Busanjin-gu (KR); Tae-Hoon Lim, Seoul (KR); Jonghee Han, Seoul (KR); Heung Yong Ha, Seoul (KR); Eun Ae Cho, Seoul (KR); Sung Pil Yoon, Seongnam-si (KR)

Correspondence Address: MERCHANT & GOULD PC, P.O. BOX 2903, MINNEAPOLIS, MN, 55402-0903, US

(73) Assignee: Korea Institute of Science & Technology, Seoul (KR)

(21) Appl. No.: 12/004,273

(22) Filed: Dec. 19, 2007

(30) Foreign Application Priority Data
Dec. 22, 2006 (KR) 10-2006-0132631

(51) Int. Cl. H01M 8/10; H01M 8/00

(52) U.S. Cl. 429/483; 429/535

(57) ABSTRACT

A membrane-electrode binder for a fuel cell, a method of manufacturing the binder, and a fuel cell comprising the binder are provided, in which the membrane-electrode binder comprises a dual electrode constituted by a first electrode and a second electrode in a two-layer form, and a polymer electrolyte membrane disposed on the dual electrode, the dual electrode comprising an electrode substrate and a catalyst layer formed thereon. In detail, the membrane-electrode binder comprises the dual electrode that is constituted by the first electrode obtained by using a PBI-based binder, the second electrode obtained by using a PTFE-based binder, and an inorganic acid doped PBI-based polymer electrolyte membrane disposed on the dual electrode and coming in contact with the first electrode. In the configuration of the dual electrode, the PBI-based binder used for manufacturing the first electrode contributes to enhancing an adhesive strength with the inorganic acid doped PBI-based polymer electrolyte membrane, and the PTFE-based binder used for manufacturing the second electrode contributes to suppressing the emission of an inorganic acid from the inorganic acid doped PBI-based polymer electrolyte membrane, together improving the performance of a fuel cell.

### CROSS-REFERENCE(S) TO RELATED APPLICATIONS

The present invention claims priority of Korean patent application number 10-2006-0132631, filed on Dec. 22, 2006, which is incorporated by reference in its entirety.

### BACKGROUND OF THE INVENTION

The present invention relates in general to a membrane-electrode binder having a dual electrode, a method of manufacturing the binder, and a fuel cell comprising the same; and, more particularly, to a membrane-electrode binder with a dual electrode for use in a fuel cell, which is applicable to a high-temperature polymer electrolyte membrane and which is capable of improving an adhesive strength between an electrode and an electrolyte membrane, a method of manufacturing the binder, and a fuel cell comprising the same.

A fuel cell is an electricity generation system by directly converting a chemical reaction energy between hydrogen and oxygen contained in a hydrocarbon-based material such as methanol, ethanol, and natural gas into an electric energy.

Depending on the kind of electrolyte used, fuel cells are largely classified into phosphoric acid fuel cells, molten carbonate fuel cells, solid oxide fuel cells, polymer electrolyte membrane fuel cells, and alkaline fuel cells. These fuel cells operate on fundamentally the same principles, but differ from each other in terms of the kind of fuel used, operating temperature, catalyst, electrolyte, and so on.

Among them, the polymer electrolyte membrane fuel cells (PEMFC) demonstrate outstanding output characteristics compared with other fuel cells, have low operating temperature, and feature fast start-up characteristics and a wide range of applications including mobile power for automotives, distributed power for residential and public buildings, small size power for electronic equipment and the like.

In order to construct a basic system of the PEMFC, stack, a reformer, a fuel tank, and a fuel pump are provided.

A fuel cell stack body, the main part of the electricity generation system of the PEMFC, comprises unit cells in a multi-layer laminate, wherein, the unit cell is manufactured by hot pressing an anode and a cathode onto both sides of a solid electrolyte made out of a polymer proton-exchange membrane, thereby generating from several Ws to several hundreds kWs of power.

Particularly, the performance of a membrane-electrode assembly (MEA) has a great controlling influence on generation characteristics of the electricity generation system of the PEMFC. The MEA is constituted by a polymer electrolyte membrane and a carbon supported catalyst electrode layer.

Examples of the polymer electrolyte membrane that are broadly used now include Nafion (product name of DuPont), Flemion (product name of Asahi Glass), Asiplex (product name of Asahi Chemical), and Dow XUS (product name of Dow Chemical), which are fluorosulfonate ionomer membranes. The carbon supported catalyst electrode layer is prepared by binding carbon powder supported on micro size catalyst particles of Pt or Ru to an electrode support made of porous carbon paper or carbon cloth by means of a waterproof binder.

### SUMMARY OF THE INVENTION

The inventors have recognized the importance of designing a suitable electrode to make use of an inorganic acid doped polybenzimidazole (PBI)-based polymer electrolyte membrane for a high-temperature fuel cell. More specifically, the inventors noticed that the electrode should have a superior adhesive strength with the PBI membrane and must be excellent in suppressing the emission of an inorganic acid contained in PBI to be able to demonstrate the best performance of the membrane.

In view of foregoing problems, it is, therefore, an object of the present invention to provide a membrane-electrode binder with a dual electrode for enhancing junction between an electrode and a membrane to make the best use of an inorganic acid doped PBI-based polymer electrolyte membrane for a high-temperature fuel cell, a method of manufacturing the binder, and a fuel cell comprising the same.

It is another object of the present invention to provide a membrane-electrode binder with a dual electrode for suppressing the emission of an inorganic acid contained in PBI to make the best use of an inorganic acid doped PBI-based polymer electrolyte membrane for a high-temperature fuel cell, a method of manufacturing the binder, and a fuel cell comprising the same.

In accordance with the present invention, there is provided a membrane-electrode binder for a cell, comprising: a dual electrode comprising a first electrode and a second electrode in a two-layer form; and a polymer electrolyte membrane placed on the dual electrode, making a contact with the first electrode, in which the dual electrode comprises an electrode substrate and a catalyst layer formed thereon.

Moreover, the present invention provides a method of manufacturing a membrane-electrode binder for a fuel cell, comprising: preparing two coating compositions for the formation of a catalyst by mixing a metal catalyst, a binder, and a solvent; preparing a dual electrode by bonding the two coating compositions to an electrode substrate, respectively; and disposing a polymer electrolyte membrane on the dual electrode and joining them.

Also, the present invention provides a fuel cell comprising the membrane-electrode binder.

According to one aspect of the invention, as depicted in FIG. 1, a membrane-electrode binder for a fuel cell comprises: a duel electrode comprising a first electrode 11 for increasing an adhesive strength with an inorganic acid doped PBI-based polymer electrolyte membrane by using a PBI-based binder, and a second electrode 12 for suppressing the emission of the inorganic acid from the polymer electrolyte membrane 10 by using a PTFE-based binder; and a PBI-based polymer electrolyte membrane 10 disposed on the dual electrode, making a contact with the first electrode 11.

According to another aspect of the invention, a method of manufacturing a membrane-electrode binder for a fuel cell comprises: obtaining a dual electrode by preparing a first electrode 11 in use of a PTFE-based binder and bonding a second electrode 12 onto the first electrode 11 by using a PBI-based binder; and disposing a polymer electrolyte membrane 10 on the first electrode 11 of the dual electrode and joining them.

The other objectives and advantages of the invention will be understood by the following description and will also be appreciated by the embodiments of the invention more clearly. Further, the objectives and advantages of the invention will readily be seen that they can be realized by the means and its combination specified in the claims.

### BRIEF DESCRIPTION OF THE DRAWINGS

FIG. 1 is a schematic diagram of a membrane-electrode binder having a dual electrode according to one embodiment of the present invention; and

FIG. 2 is a graph comparing performances of unit cells comprising an electrode using polytetrafluoroethylene (PTFE)-based binder, an electrode using polybenzimidazole (PBI)-based binder, and a dual electrode, respectively.

### DESCRIPTION OF SPECIFIC EMBODIMENTS

Hereinafter, preferred examples of the present invention will be set forth in detail with reference to the accompanying drawings so that those skilled in the art can easily carry out the invention.

The present invention is directed to a membrane-electrode binder suitable for use in a high-temperature fuel cell, and a fuel cell electrode used for the membrane-electrode binder is a double electrode constituted by a first electrode and a second electrode in a two-layer form.

Particularly, the first electrode of a dual electrode according to one embodiment of the present invention is obtained by using an inorganic acid doped PBI-based binder which contributes to an enhanced adhesive strength with the PBI-based polymer electrolyte membrane, while the second electrode of the dual electrode is obtained by using a binder containing PTFE as an active component which contributes to suppression of the emission of an inorganic acid.

A method of manufacturing a membrane-electrode binder of the present invention comprises: preparing a coating composition for the formation of a catalyst by mixing a metal catalyst, a binder, and a solvent; coating an electrode substrate with the coating composition to produce an electrode; and disposing a polymer electrolyte membrane on the electrode and joining them.

In a method of manufacturing a membrane-electrode binder according to one example of the present invention, a dual electrode is manufactured by preparing a first electrode in use of a PTFE-based binder and bonding a second electrode onto the first electrode with a PBI-based binder. Next, a polymer electrolyte membrane, preferably, an inorganic acid doped PBI-based polymer electrolyte membrane is disposed on the dual electrode, and the membrane and the electrode are joined together.

In order to manufacture an electrode for a fuel cell, a carbon supported metal catalyst, a binder, and a solvent used as a dispersion medium are mixed together to prepare a coating composition for the formation of a catalyst, and the coating composition is then applied to an electrode substrate.

The electrode substrate functions as a gas diffusion layer and is composed of a conductive substrate. Carbon paper or carbon cloth may be utilized for the gas diffusion layer, but the present invention is not limited thereto.

The gas diffusion layer not only supports an electrode for a fuel cell but also diffuses a reaction gas towards a catalyst layer, providing an easy access of the reaction gas to the catalyst layer. In addition, carbon paper or carbon cloth used for the gas diffusion layer preferably undergoes water-repelling finishing with a fluorinated resin such as PTFE so that the diffusion rate of a gas may not be deteriorated by water that is produced during the operation of a fuel cell.

The catalyst layer in the present invention electrode contains a metal catalyst to catalytically promote relevant reactions (oxidation of hydrogen and reduction of oxygen). Specific examples of the metal catalyst include, but are not limited to, Pt, Ru, Os, Pt—Ru alloy, Pt—Os alloy, Pt—Pd alloy, and Pt-M alloy (M is at least one transition metal selected from the group consisting of Ga, Ti, V, Cr, Mn, Fe, Co, Ni, Cu and Zn).

Moreover, a carrier-supported metal catalyst is generally employed. As for the carrier, carbon particles such as acetylene block, graphite, or inorganic particles such as alumina, silica may be utilized. In case of using a carrier-supported metal as a catalyst, any metal catalysts commercially available can be used or the carrier-supported metal may be prepared at firsthand.

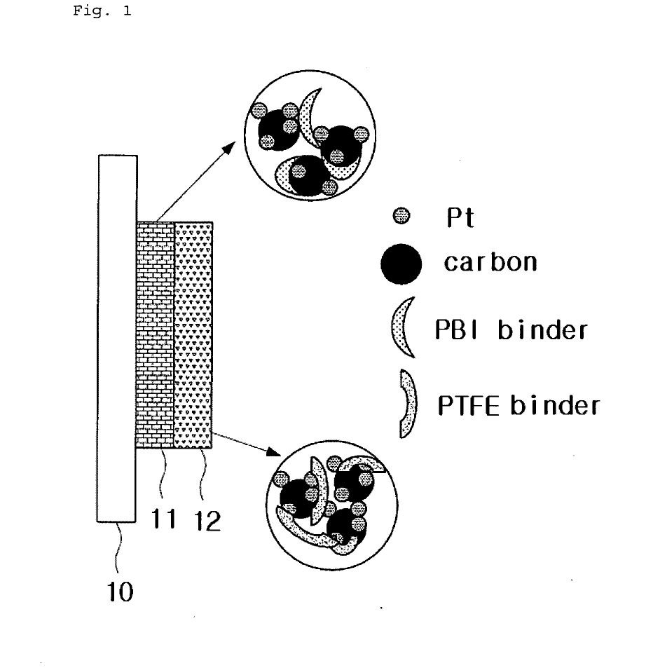

As shown in FIG. 1, according to one example of the present invention, Pt was used as the metal catalyst and carbon was used as a carrier for supporting the metal. That is, a carbon-supported Pt was used as a catalyst in this example.

According to one example of the present invention, solvent such as alcohol, a polar organic solvent may be used as the solvent functioning as the dispersion medium. Specific examples of the solvent include, but are not limited to, isopropyl alcohol, N-methylpyrrolidone (NMP), acetone and the like.

According to one example of the present invention, the binder and/or the polymer electrolyte membrane contained in the catalyst layer uses a PBI-based polymer represented by the following chemical formula I.

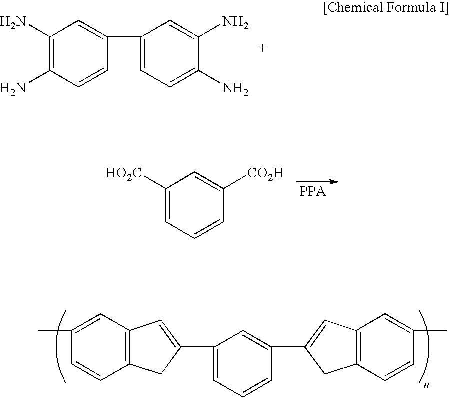

wherein, n indicates a degree of polymerization.

The PBI-based polymer is proton conductive and increases an adhesive strength between an electrode and a membrane when used for the electrode catalyst layer. Therefore, at least the first electrode or the polymer electrolyte membrane, or both of them may use a PBI-based polymer. In this manner, the present invention makes it possible to reduce interface interference that sometimes occurs to an interface between an electrode and a polymer electrolyte membrane, so that the electrode and the polymer electrolyte membrane can be bonded to each other firmly and evenly.

Lastly, the polymer electrolyte membrane is composed of a proton conducting polymer, such as, ionomer. Examples of the proton conducting polymer preferably include, but are not limited to, a copolymer of tetrafluoroethylene and fluorovinylether containing sulfonic acid groups, fluoride-free poly(ether sulfide ketone), and aryl ketone.

According to one example of the present invention, a PBI-based polymer and a membrane for use in the present invention are synthesized as follows.

12 g of 3,3′-diaminobenzidine and 9.3 g of isophthalic acid were placed in a 1 L round bottom flask filled with polyphosphoric acid and polymerized under nitrogen atmosphere at 220° C. for 25 hours.

The mixed solution was stirred by a mechanical overhead stirrer. When the stirring speed was set to 100 RPM at room temperature, viscosity of polyphosphoric acid was reduced with increasing temperature so the stirring speed was increased up to 300 RPM. As the reaction progresses however, the viscosity of the solution was increased so the final stirring speed was set between 180 and 200 RPM.

In addition, when the reaction progresses, the solution turns from yellow ocher to dark brown in color. The resulting brown solution was precipitated in water to produce a polymer. The polymer was then dried in a 100° C. vacuum oven for 24 hours to prepare PBI powder having an intrinsic viscosity of about 1.5-3.0 dL/g.

5 g of the PBI powder was dissolved in 100 mL DMAc, poured onto a glass plate, and casted with a doctor blade. The resulting cast was dried in a 60° C. vacuum oven for 50 hours to obtain a PBI membrane. Finally, the PBI membrane was impregnated in a 60% phosphoric acid bath for 3 days and a 400% doped polymer electrolyte membrane was obtained.

According to another example of the present invention, a PBI-based polymer and a membrane for use in the present invention can be synthesized as follows.

12 g of 3,3′-diaminobenzidine and 9.3 g of isophthalic acid were placed in a 1 L round bottom flask filled with polyphosphoric acid and polymerized under nitrogen atmosphere at 220° C. for 25 hours.

The mixed solution was stirred by a mechanical overhead stirrer. When the stirring speed was set to 100 RPM at room temperature, viscosity of polyphosphoric acid was reduced with increasing temperature so the stirring speed was increased up to 300 RPM. As the reaction progresses however, the viscosity of the solution was increased so the final stirring speed was set between 180 and 200 RPM.

In addition, when the reaction progresses, the solution turns from yellow ocher to dark brown in color.

A suitable amount of the brown PBI solution was poured onto a clean glass plate and casted with a doctor blade.

The casted PBI membrane was kept at 25° C. and 40±5% relative humidity for about one day. In so doing, polyphosphoric acid in the PBI membrane turned to phosphoric acid by reacting with moisture in the air, and a PBI membrane having an acid doping level of 2000 or higher was obtained. Thusly obtained PBI membrane can be 200-600 μm in thickness.

The PBI-based polymer in a composition for the formation of the catalyst is not in a dissolved state but in a dispersed state. Moreover, examples of the casting method for a membrane include, but are not limited to, coating in use of a doctor blade, screen printing, and spray coating, according to the viscosity of a dispersion used.

Meanwhile, a cathode electrode and an anode electrode for a fuel cell are distinguished not by their materials but by their roles. Electrodes for a fuel cell are usually divided into an anode for hydrogen oxidation and a cathode for oxygen reduction. Therefore, the prevent invention electrode for a fuel cell can be utilized as at least one of the cathode and anode electrodes, and preferably as both electrodes.

That is, hydrogen or fuel is supplied to the anode and oxygen is supplied to the cathode, and an electrochemical reaction between the anode and the cathode generates electricity. Oxidation of an organic fuel at the anode and reduction of oxygen at the cathode give rise to a voltage difference between the two electrodes.

The examples of the present invention will be described in detail together with the comparative examples. However, the examples hereinafter are for illustrative purposes only, and the present invention is not limited thereto.

### EXPERIMENTAL EXAMPLES

### Example and Comparative Examples

### Example

### Manufacture of Dual Electrode

0.4 g of 60% PTFE emulsion was put in 400 ml of iso-propanol (IPA) and dispersed for about 30 minutes by using a stirring bar. 1.225 g of E-Tek 40% Pt/C was carefully added thereto and stirred for about 1 hour. A resulting ink slurry obtained from the mixture of Pt/C and PTFE was sprayed evenly over a gas diffusion layer (GDL) by means of an air brush. The loading amount of Pt/C was set to 0.5 mg per cm². Thusly obtained electrode was placed in a calciner to be sintered at 365° C. for one hour under nitrogen atmosphere and then reduced at 250° C. for one hour under hydrogen atmosphere.

PBI powder was dissolved in dimethylacetamide (DMAc) to prepare a 5% solution. 4.9 g of the solution was dispersed in 400 ml of iso-propanol (IPA) under ultrasonic vibration for 30 minutes. Next, 1.225 g of E-Tek 40% Pt/C was carefully added thereto and dispersed again for about 1 hour. A resulting ink slurry obtained from the mixture of Pt/C and PBI was sprayed evenly over a gas diffusion layer (GDL) coated with PTFE and Pt/C by means of an air brush. The loading amount of Pt was set to 0.5 mg per cm². Thusly obtained electrode was placed in a 100° C. vacuum oven and dried for 3 hours to completely remove several solvents contained in the electrode.

PTFE: PBI layer (Thickness)=0.1:1˜1:0.1

### Comparative Example I

### Manufacture of Electrode Using PTFE-Based Binder

0.4 g of 60% PTFE emulsion was put in 400 ml of iso-propanol (IPA) and dispersed for about 30 minutes by using a stirring bar. 1.225 g of E-Tek 40% Pt/C was carefully added thereto and stirred for about 1 hour. A resulting ink slurry obtained from the mixture of Pt/C and PTFE was sprayed evenly over a gas diffusion layer (GDL) by means of an air brush. The loading amount of Pt/C was set to 1 mg per cm². Thusly obtained electrode was placed in a calciner to be sintered at 365° C. for one hour under nitrogen atmosphere and then reduced at 250° C. for one hour under hydrogen atmosphere.

### Comparative Example II

### Manufacture of Electrode Using PBI-Based Binder

PBI powder was dissolved in dimethylacetamide (DMAc) to prepare a 5% solution. 4.9 g of the solution was dispersed in 400 ml of iso-propanol (IPA) under ultrasonic vibration for 30 minutes. Next, 1.225 g of E-Tek 40% Pt/C was carefully added thereto and dispersed again for about 1 hour. A resulting ink slurry obtained from the mixture of Pt/C and PBI was sprayed evenly over a gas diffusion layer (GDL) by means of an air brush. The loading amount of Pt/C was set to 1 mg per cm². Thusly obtained electrode was placed in a 100° C. vacuum oven and dried for 3 hours to completely remove the DMAc contained in the electrode.

### Comparative Example III

### Manufacture of Electrode Using PTFF-PBI Binary Binder

PBI powder was dissolved in dimethylacetamide (DMAc) to prepare a 5% solution. The solution was then mixed with dispersion which was prepared by mixing iso-propanol (IPA) and a 60% PTFE emulsion. Next, 1.225 g of E-Tek 40% Pt/C was carefully added thereto and dispersed again for about 1 hour. A resulting ink slurry was sprayed evenly over a gas diffusion layer (GDL) by means of an air brush. The loading amount of Pt/C was set to 1 mg per cm². Thusly obtained electrode was placed in a 100° C. vacuum oven and dried for 3 hours to completely remove several solvents contained in the electrode.

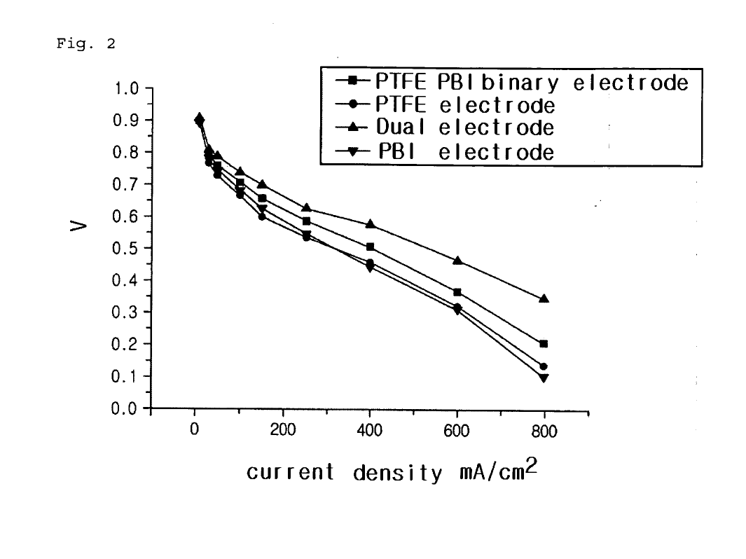

FIG. 2 shows performances of unit cells composed of the electrodes obtained in the Example and the Comparative Examples 1-3, i.e., a dual electrode, an electrode using a PTFE-based binder, an electrode using a PBI-based binder, and an electrode using a PTFE-PBI binary binder, respectively. The performance measurement was carried out at 2000% doping level and 150° C. operation temperature of the unit cell, using an anode implanted with hydrogen and a cathode implanted with air.

As apparent from the results shown on the graph of FIG. 2, the unit cell composed of a dual electrode demonstrated an outstanding performance compared to other unit cells composed of an electrode using the PTFE-based binder, an electrode using the PBI-based binder, and an electrode using the PTFE-PBI binary binder.

Therefore, the membrane-electrode binder having a dual electrode and its manufacturing method according to the present invention are advantageous for improving performances of a fuel cell comprising an inorganic acid doped polybenzimidazole (PBI)-based polymer electrolyte membrane for a high-temperature fuel cell, i.e., enhancing junction between the electrode and the membrane and suppressing the emission of an inorganic acid contained in the PHI.

While the present invention has been described with respect to the specific embodiments, it will be apparent to those skilled in the art that various changes and modifications may be made without departing from the spirit and scope of the invention as defined in the following claims.

1. A membrane-electrode binder for a fuel cell, comprising:
a dual electrode comprising a first electrode and a second electrode in a two-layer form; and
a polymer electrolyte membrane disposed on the dual electrode and coming in contact with the first electrode.

2. The membrane-electrode binder according to claim 1,
wherein the first electrode is manufactured by using a PBI-based binder for enhancing an adhesive strength with the polymer electrolyte membrane,
wherein the second electrode is manufactured by using a PTFE-based binder for suppressing the emission of an inorganic acid from the polymer electrolyte membrane, and
wherein the polymer electrolyte membrane is an inorganic acid doped PBI-based polymer electrolyte membrane.

3. The membrane-electrode binder according to claim 1, wherein the dual electrode comprises an electrode substrate and a catalyst layer formed thereon.

4. The membrane-electrode binder according to claim 3, wherein the electrode substrate is a gas diffusion layer made of a gas conductive substrate and comprises a water repellent treated carbon paper or carbon cloth in presence of PTFE.

5. The membrane-electrode binder according to claim 3, wherein the catalyst layer contains a metal catalyst selected from the group consisting of Pt, Ru, Os, Pt—Ru alloy, Pt—Os alloy, Pt—Pd alloy, and Pt-M alloy (M is at least one transition metal selected from the group consisting of Ga, Ti, V, Cr, Mn, Fe, Co, Ni, Cu and Zn).

6. The membrane-electrode binder according to claim 5, wherein the metal catalyst is supported on carbon.

7. A method of manufacturing a membrane-electrode binder for a fuel cell, comprising:
manufacturing a first electrode;
forming a second electrode on the first electrode to obtain a dual electrode; and
disposing a polymer electrolyte membrane on the first electrode of the dual electrode and joining the same.

8. The method according to claim 7,
wherein the first electrode is manufactured by using a PBI-based binder for enhancing an adhesive strength with the polymer electrolyte membrane,
wherein the second electrode is manufactured by using a PTFE-based binder for suppressing the emission of an inorganic acid from the polymer electrolyte membrane, and
wherein the polymer electrolyte membrane is an inorganic acid doped PBI-based polymer electrolyte membrane.

9. The method according to claim 7, wherein the dual electrode is manufactured by preparing two coating compositions for the formation of catalysts by mixing a metal catalyst, a binder and a solvent, and applying the two coating compositions onto an electrode substrate respectively to obtain a dual electrode.

10. The method according to claim 9, wherein the electrode substrate is a gas diffusion layer made of a gas conductive substrate and comprises a water repellent treated carbon paper or carbon cloth in presence of PTFE.

11. The method according to claim 9, wherein the metal catalyst is selected from the group consisting of Pt, Ru, Os, Pt—Ru alloy, Pt—Os alloy, Pt—Pd alloy, and Pt-M alloy (M is at least one transition metal selected from the group consisting of Ga, Ti, V, Cr, Mn, Fe, Co, Ni, Cu and Zn).

12. The method according to claim 11, wherein the metal catalyst is supported on carbon.

13. The method according to claim 9, wherein the solvent is selected from the group consisting of alcohol, N-methylpyrrolidone (NMP) and acetone.

14. A fuel cell comprising a membrane-electrode binder according to claim 1.

15. The membrane-electrode binder according to claim 2, wherein the dual electrode comprises an electrode substrate and a catalyst layer formed thereon.

16. The method according to claim 8, wherein the dual electrode is manufactured by preparing two coating compositions for the formation of catalysts by mixing a metal catalyst, a binder and a solvent, and applying the two coating compositions onto an electrode substrate respectively to obtain a dual electrode.

17. A fuel cell comprising a membrane-electrode binder according to claim 2.
